(19) United States
(12) Patent Application Publication
(10) Pub. No.: US 2013/0112615 A1
(43) Pub. Date: May 9, 2013

(54) ORGANIC/INORGANIC FOULING RESISTANT HYBRID COMPOUND, FOULING RESISTANT MEMBRANE, AND METHOD OF PREPARING FOULING RESISTANT MEMBRANE

(71) Applicants: Hyo Kang, Seoul (KR); Sung Soo Han, Gyeonggi-do (KR)

(72) Inventors: Hyo Kang, Seoul (KR); Sung Soo Han, Gyeonggi-do (KR)

(73) Assignee: SAMSUNG ELECTRONICS CO., LTD., Suwon-si (KR)

(21) Appl. No.: 13/494,359

(22) Filed: Jun. 12, 2012

(30) Foreign Application Priority Data
Nov. 3, 2011 (KR) 10-2011-0114175

(51) Int. Cl. B01D 71/82; B01D 67/00; B01D 69/12; C08G 77/14; B32B 9/04

(52) U.S. Cl. 210/500.28; 528/26; 428/334; 428/447; 428/412; 428/422; 428/421; 428/413; 427/244

(57) ABSTRACT

An organic/inorganic fouling resistant composite compound is disclosed, which includes a core of a polyhedron of polyhedral oligomeric silsesquioxane and at least one arm connected to a silicon atom of the polyhedral oligomeric silsesquioxane. The at least one arm includes a vinyl-based first structural unit including at least one ethylene oxide group at a side chain of the vinyl-based first structural unit and an oleophobic vinyl-based second structural unit including a silicon group at the side chain.

### CROSS-REFERENCE TO RELATED APPLICATION

This application claims priority, under 35 U.S.C. §119, to and the benefit of Korean Patent Application No. 10-2011-0114175 filed in the Korean Intellectual Property Office on Nov. 3, 2011, the entire contents of which are incorporated herein by reference.

### BACKGROUND

1. Field

Example embodiments are directed to an organic/inorganic fouling resistant composite compound, a fouling resistant membrane, and a method of preparing a fouling resistant membrane.

2. Description of the Related Art

Membrane fouling is one problem in the membrane industry. It is characterized by a decrease in the membrane permeation rate over time, which is generally induced by components in a feed solution passing through the membrane. It may be caused by molecule adsorption in the membrane pores, pore blocking, or cake formation on the membrane surface. A decrease in permeation rate increases operation energy use, and to overcome this, cleaning is required. However, this is only a temporary solution, and fouling typically decreases the life-span of the membrane.

As a method for reducing fouling of membranes for reverse osmotic pressure (RO), forward osmotic pressure (FO), ultrafiltration (UF), and microfiltration (MF), imparting a hydrophilic surface to the membrane is a fundamental solution that is capable of providing fouling resistance while increasing the life-span of the membrane.

To increase fouling resistance of a membrane by graft polymerization of a hydrophilic group on the membrane surface, various hydrophilic monomers are grafted by various synthesis membranes to restrict fouling by microorganisms (e.g., bacteria and the like) and natural organic materials (e.g., proteins and the like). An important drawback of the surface modification method is the initiation of graft polymerization using high energy gamma radiation or plasma. This approach may increase membrane manufacturing costs, and it is not controlled well.

### SUMMARY

Example embodiments are directed to an organic/inorganic fouling resistant composite compound, a fouling resistant membrane, and a method of preparing a fouling resistant membrane.

Example embodiments provide an organic/inorganic composite compound that may be used in the preparation of a fouling resistant membrane, which prevents a biofilm or an oil film from forming thereon while having hydrophilicity.

Example embodiments provide a membrane with fouling resistance to which fouling resistance is given using the organic/inorganic composite compound for fouling resistance.

Yet other example embodiments provide a method of preparing the membrane with fouling resistance to which fouling resistance is given using the organic/inorganic composite compound for fouling resistance.

According to example embodiments, provided is an fouling resistant organic/inorganic composite compound including a core of a polyhedron of a polyhedral oligomeric silsesquioxane, and at least one arm connected to a silicon (Si) atom of the polyhedral oligomeric silsesquioxane, wherein the at least one arm includes a vinyl-based first structural unit and an oleophobic vinyl-based second structural unit. The vinyl-based first structural unit includes at least one ethylene oxide group at a side chain of the vinyl-based first structural unit. The oleophobic vinyl-based second structural unit includes a silicon group at the side chain.

An atomic ratio of silicon (Si) to oxygen (O) in the polyhedron of the polyhedral oligomeric silsesquioxane may be about 1:1 to 3/2.

The polyhedron of the polyhedral oligomeric silsesquioxane may be one selected from a pentahedron of the following Chemical Formula 1, a hexahedron of the following Chemical Formula 2, a heptahedron of the following Chemical Formula 3, an octahedron of the following Chemical Formula 4, an enneahedron of the following Chemical Formula 5, a decahedron of the following Chemical Formula 6 and derivatives thereof.

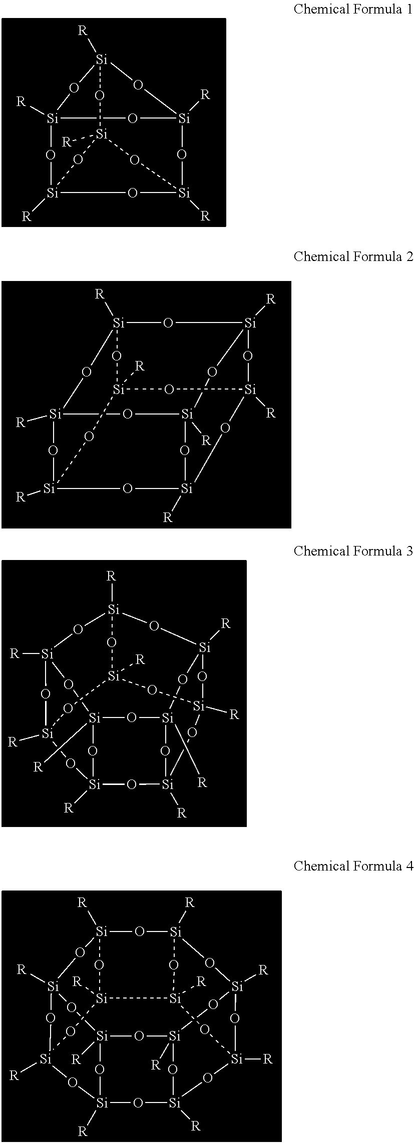

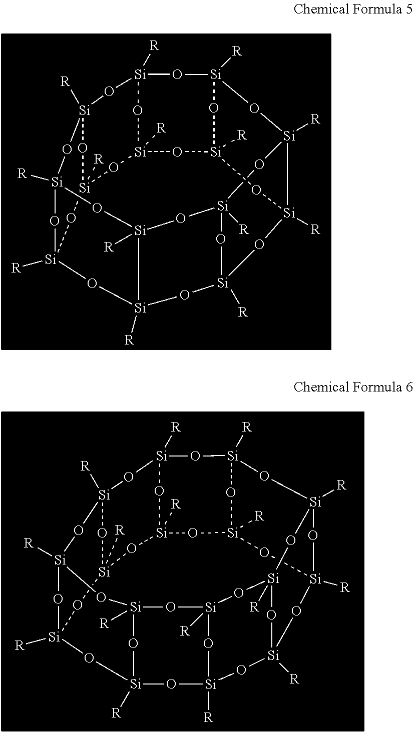

In Chemical Formulas 1 to 6, groups represented by R's are the same or different, and are each independently one selected from hydrogen, a hydroxy group, a nitro group, a cyano group, an imino group (═NH, ═NR¹⁰¹, wherein R¹⁰¹ is a C1 to C10 alkyl group), an amino group (—NH₂, —NH(R¹⁰²), and —N(R¹⁰³)(R¹⁰⁴), wherein R¹⁰² to R¹⁰⁴ are each independently a C1 to C10 alkyl group), an amidino group, a hydrazine group, a hydrazone group, a carboxyl group, a C1 to C30 alkyl group, a C1 to C30 alkylsilyl group, a C3 to C30 cycloalkyl group, a C2 to C30 heterocycloalkyl group, a C6 to C30 aryl group, a C2 to C30 heteroaryl group, a C1 to C30 alkoxy group, a C1 to C30 fluoroalkyl group, and an *L¹-A group (wherein L¹ is a linking group and A is the arm), provided that at least one group represented by R is an *L¹-A group.

The polyhedron may include a closed polyhedron having oxygen (O) in at least one —Si—O—Si— bond unsubstituted and connected in the closed polyhedron.

The polyhedron may include an open polyhedron having O in at least one —Si—O—Si— bond of Chemical Formulas 1 to 6 substituted with substituents and disconnected in the polyhedron.

The core may be connected by 1 to 16 arms.

The vinyl-based first structural unit including the side chain with at least one ethylene oxide group may be a structural unit represented by the following Chemical Formula 7.

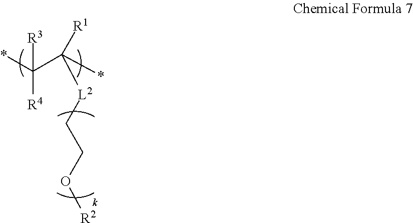

In the above Chemical Formula 7, L² is one selected from a single bond, —O—, —OOC—, —COO—, —OCOO—, —NHCO—, —CONH—, —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 an alkylarylene group, a substituted or unsubstituted C2-C30 arylalkylene group, and a group where at least one group of the foregoing groups is linked together. R¹, R², R³, and R⁴ are each independently one selected from hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, and a substituted or unsubstituted C2-C30 arylalkyl group. K is an integer ranging from 1 to 500.

The average k value of Chemical Formula 7 in the at least one arm may be about 5 to about 100.

In the oleophobic vinyl-based second structural unit including a silicon group at the side chain, the silicon group may include at least one selected from a silane group, a siloxane group, and a combination thereof.

The oleophobic vinyl-based second structural unit may be a structural unit represented by the following Chemical Formula 9.

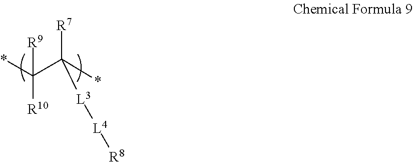

In the above Chemical Formula 9, R⁷, R⁹, and R¹⁰ are each independently one selected from hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, and a substituted or unsubstituted C2-C30 arylalkyl group. L³ is one selected from a single bond, —O—, —OOC—, —COO—, —OCOO—, —NHCO—, —CONH—, —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 alkylarylene group, a substituted or unsubstituted C2-C30 arylalkylene group, and a group where at least one group of the foregoing groups is linked together. L⁴ is one selected from a single bond, —O—, —OOC—, —COO—, —OCOO—, —NHCO—, —CONH—, —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 alkylarylene group, a substituted or unsubstituted C2-C30 arylalkylene group, and a group where at least one group of the foregoing groups is linked together. R⁸ is one of groups represented by the following Chemical Formulas 10 to 15.

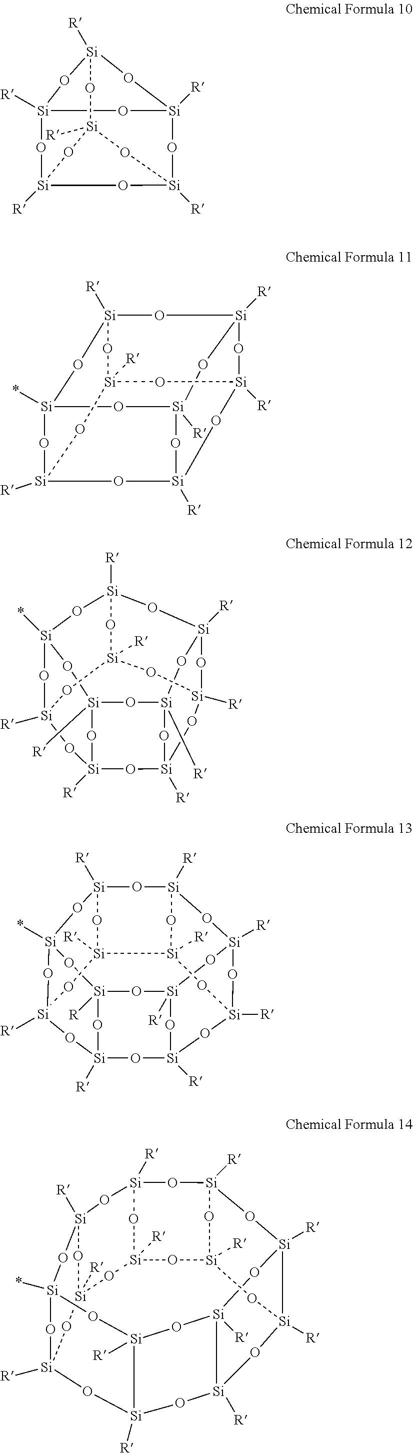

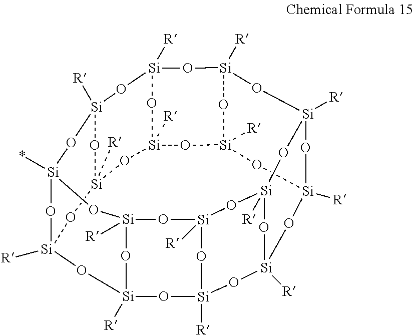

In the above Chemical Formulas 10 to 15, R′ are the same or different, and are independently one selected from hydrogen, a hydroxy group, a nitro group, a cyano group, an imino group (═NH, ═NR¹⁰¹, wherein R¹⁰¹ is a C1 to C10 alkyl group), an amino group (—NH₂, —NH(R¹⁰²), —N(R¹⁰³)(R¹⁰⁴), wherein R¹⁰² to R¹⁰⁴ are independently a C1 to C10 alkyl group), an amidino group, a hydrazine group, a hydrazone group, a carboxyl group, a C1 to C30 alkyl group, a C1 to C30 alkylsilyl group, a C3 to C30 cycloalkyl group, a C2 to C30 heterocycloalkyl group, a C6 to C30 aryl group, a C2 to C30 heteroaryl group, C1 to C30 alkoxy group, and a C1 to C30 fluoroalkyl group.

The molar ratio of first structural unit and the second structural unit in the at least one arm may range from about 1 mol %: about 99 mol % to about 99 mol %: about 1 mol %.

The L¹ is one selected from a single bond, —O—, —OOC—, —COO—, —OCOO—, —NW— (wherein W is hydrogen or a C1-C10 alkyl group), —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 an alkylarylene group, a substituted or unsubstituted C2-C30 arylalkylene group, a substituted or unsubstituted silylene, a substituted or unsubstituted C2-C30 alkenyl group, a substituted or unsubstituted C2-C30 alkynyl group, and a group where at least one group of the foregoing groups is linked together.

The vinyl-based structural first structural unit may include a first ethylene oxide group and a second ethylene oxide group extending from the first ethylene oxide group.

According to example embodiments, a fouling resistant membrane is provided that includes a surface layer including the organic/inorganic fouling resistant composite compound.

The surface layer may have a contact angle of about 10 to about 90 degrees.

The surface layer has a thickness of about 0.01 μm to about 100 μm.

The fouling resistance membrane may further include an inner layer under the surface layer. The inner layer may include at least one compound selected from a polyacrylate-based compound, a polymethacrylate-based compound, a polystyrene-based compound, a polycarbonate-based compound, a polyethylene terephthalate-based compound, a polyimide-based compound, a polybenzimidazole-based compound, a polybenzthiazole-based compound, a polybenzoxazole-based compound, a polyepoxy resin compound, a polyolefin-based compound, a polyphenylene vinylene compound, a polyamide-based compound, a polyacrylonitrile-based compound, a polysulfone-based compound, a cellulose-based compound, polyvinylidene fluoride (PVDF), polytetrafluoroethylene (PTFE), a polyvinylchloride (PVC) compound, and a combination thereof.

According to example embodiments, provided is a water treatment membrane including the fouling resistant membrane. The fouling resistant membrane may include an inner layer and the surface layer, wherein the inner layer may be one selected from a microfiltration membrane, an ultrafiltration membrane, a nanofiltration membrane, a reverse osmotic membrane, and a forward osmotic membrane.

The inner layer may be a single membrane formed of a homogeneous material, or a composite membrane including a plurality of layers formed of a heterogeneous material.

According to yet other example embodiments, a method of preparing a fouling resistant membrane is provided that includes preparing a solution including the organic/inorganic fouling resistant composite compound and a solvent, and forming a surface layer by coating a solution on a surface of a preliminary membrane.

The surface layer may be formed by coating the solution on the surface of the preliminary membrane by one selected from solvent casting, spin casting, wet spinning, dry spinning, melt processing, and melt spinning.

The solution may include about 0.1 to about 50 wt % of the organic/inorganic fouling resistance composite compound.

### BRIEF DESCRIPTION OF THE DRAWINGS

Example embodiments will be more clearly understood from the following detailed description taken in conjunction with the accompanying drawings. FIGS. 1-11 represent non-limiting, example embodiments as described herein.

FIGS. 1(a) and 1(b) are schematic views showing the shape of an organic/inorganic composite compound for fouling resistance according to example embodiments,

FIG. 2 is a schematic view of a membrane with fouling resistance including a surface layer and an inner layer according to example embodiments;

FIG. 3 shows a hydrogen nuclear magnetic resonance spectrum of the compound synthesized in Example 1;

FIG. 4 shows a hydrogen nuclear magnetic resonance spectrum of the compound synthesized in Example 2;

FIG. 5 shows a hydrogen nuclear magnetic resonance spectrum of the compound synthesized in Comparative Example 1;

FIG. 6 shows a hydrogen nuclear magnetic resonance spectrum of the compound synthesized in Comparative Example 2;

FIGS. 7(a), 7(b), 7(c) and 7(d) show scanning electron microscope photographs of the membranes with fouling resistance manufactured so as to form a surface layer including the compounds synthesized in Example 1, Example 2 and Comparative Example 1; and

FIGS. 8 to 11 shows changes in the amount of water permeation of the separation membranes manufactured so as to form a surface layer including the compounds synthesized in Example 1, Example 2, and Comparative Example 5 over time.

### DETAILED DESCRIPTION

Various example embodiments will now be described more fully with reference to the accompanying drawings in which some example embodiments are shown. However, specific structural and functional details disclosed herein are merely representative for purposes of describing example embodiments. Thus, the invention may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the invention.

In the drawings, the thicknesses of layers and regions may be exaggerated for clarity, and like numbers refer to like elements throughout the description of the figures.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments, various aspects will be described in detail with reference to the attached drawings. However, the present invention is not limited to example embodiments described.

As used herein, when a definition is not otherwise provided, the term “substituted” may refer to one substituted with a halogen (F, Cl, Br, or I); a hydroxy group; a nitro group; a cyano group; an imino group (═NH or ═NR¹⁰¹, wherein R¹⁰¹ is a C1 to C10 alkyl group); an amino group (—NH₂, —NH(R¹⁰²), and —N(R¹⁰³)(R¹⁰⁴), wherein R¹⁰² to R¹⁰⁴ are each independently a C1 to C10 alkyl group); an amidino group; a hydrazine group; a hydrazone group; a carboxyl group; a C1 to C30 alkyl group; a C1 to C30 alkylsilyl group; a C3 to C30 cycloalkyl group; a C2 to C30 heterocycloalkyl group; a C6 to C30 aryl group; a C2 to C30 heteroaryl group; a C1 to C30 alkoxy group; or a C1 to C30 fluoroalkyl group.

As used herein, when a definition is not otherwise provided, the prefix “hetero” may refer to one including 1 to 3 heteroatoms selected from N, O, S, and P, and remaining carbons in a compound or a substituent.

As used herein, when a definition is not otherwise provided, the term “combination thereof” refers to at least two substituents bound to each other by a linker, or at least two substituents condensed to each other.

As used herein, when a definition is not otherwise provided, the term “alkyl group” may refer to a “saturated alkyl group” without an alkenyl group or an alkynyl group, or an “unsaturated alkyl group” including at least one of an alkenyl group and an alkynyl group. The term “alkenyl group” may refer to a substituent in which at least two carbon atoms are bound in at least one carbon-carbon double bond, and the term “alkynyl group” refers to a substituent in which at least two carbon atoms are bound in at least one carbon-carbon triple bond. The alkyl group may be a branched, linear, or cyclic alkyl group.

The alkyl group may be a C1 to C20 alkyl group, and more specifically a C1 to C6 alkyl group, a C7 to C10 alkyl group, or a C11 to C20 alkyl group.

For example, a C1-C4 alkyl may have 1 to 4 carbon atoms, and may be selected from methyl, ethyl, propyl, iso-propyl, n-butyl, iso-butyl, sec-butyl, and t-butyl.

Examples of the alkyl group include a methyl group, an ethyl group, a propyl group, an isopropyl group, a butyl group, an isobutyl group, a t-butyl group, a pentyl group, a hexyl group, an ethenyl group, a propenyl group, a butenyl group, a cyclopropyl group, a cyclobutyl group, a cyclopentyl group, a cyclohexyl group, and the like.

The term “aromatic group” may refer a substituent including a cyclic structure where all elements have p-orbitals that form conjugation. An aryl group and a heteroaryl group may be exemplified.

The term “aryl group” may refer to a monocyclic or fused ring-containing polycyclic (i.e., rings sharing adjacent pairs of carbon atoms) groups.

The “heteroaryl group” may refer to one including 1 to 3 heteroatoms selected from N, O, S, or P in an aryl group, and remaining carbons. When the heteroaryl group is a fused ring, each ring may include 1 to 3 heteroatoms.

As used herein, the symbol “*” refers to a point connected to another atom or chemical formula.

Example embodiments are directed to an organic/inorganic fouling resistant composite compound, a fouling resistant membrane, and a method of preparing a fouling resistant membrane.

The organic/inorganic composite compound for fouling resistance according to example embodiments includes a core and an arm, wherein the core is formed of a polyhedron of polyhedral oligomeric silsesquioxane. The organic/inorganic composite compound for fouling resistance includes at least one arm connected to a Si atom of the polyhedral oligomeric silsesquioxane.

The number of arms of the organic/inorganic composite compound for fouling resistance is not particularly limited but may be at most a quantity that correlates to the number of Si atoms included in the polyhedral oligomeric silsesquioxane. When 3 or more arms are included, the organic/inorganic composite compound may form a star shape.

The atomic ratio of Si to O in the polyhedron of the polyhedral oligomeric silsesquioxane may be about 1:1 to 3/2. When the atomic ratio of Si:O is 1:3/2, all of the Si atoms are connected to three adjacent Si atoms with an O atom therebetween, so as to form an —Si—O—Si— bond, thus forming a polyhedron of a closed structure.

The polyhedral oligomeric silsesquioxane may include a polyhedron of an open structure wherein a part of the —Si—O—Si— bond is disconnected, as well as a polyhedron of a closed structure having the atomic ratio of Si:O of 1:3/2. For example, the polyhedron of an open structure may be formed when O in at least one —Si—O—Si— bond of the polyhedral oligomeric silsesquioxane is substituted by substituents thus breaking the —Si—O—Si— bond. The substituent may be as explained above without specific limitations. However, if substituents having a relatively strong hydrophobic characteristic are introduced, it may be difficult to impart hydrophilicity to a desired degree to the organic/inorganic composite compound for fouling resistance. Thus, if one were seeking to provide an organic/inorganic composite compound for fouling resistance by performing a method that improves hydrophilicity (e.g., a membrane for water treatment), hydrophilic substituents may be included on the organic/inorganic composite compound to improve permeability performance of the membrane.

Specific examples of the polyhedral oligomeric silsesquioxane may be a pentahedron of the following Chemical Formula 1, a hexahedron of the following Chemical Formula 2, a heptahedron of the following Chemical Formula 3, an octahedron of the following Chemical Formula 4, an enneahedron of the following Chemical Formula 5, and a decahedron of the following Chemical Formula 6.

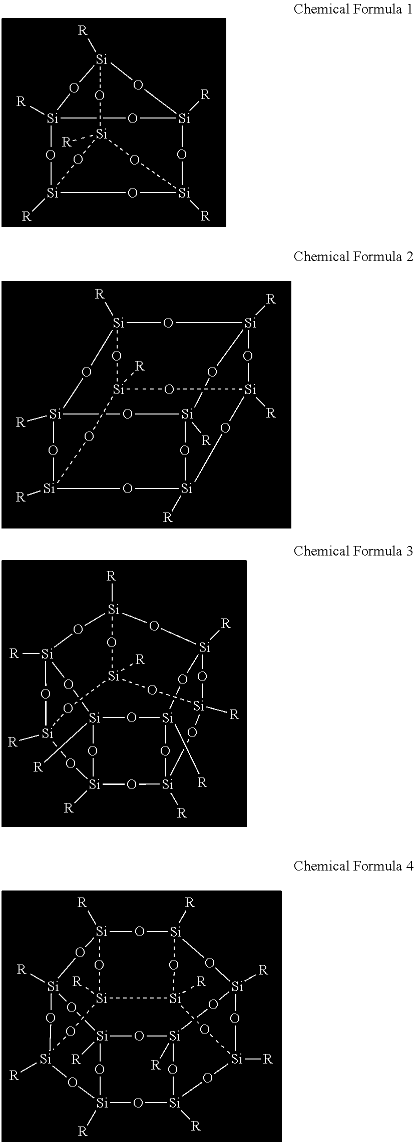

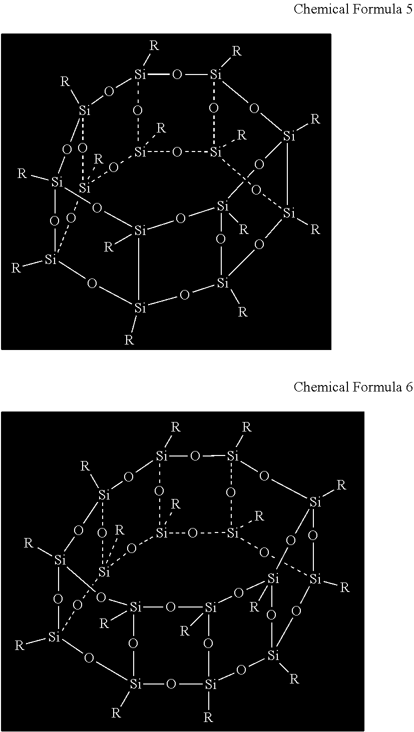

In Chemical Formulas 1 to 6, groups represented by R's are the same or different, and are each independently, hydrogen, a hydroxy group, a nitro group, a cyano group, an imino group (═NH, ═NR¹⁰¹, wherein R¹⁰¹ is a C1 to C10 alkyl group), an amino group (—NH₂, —NH(R¹⁰²), and —N(R¹⁰³)(R¹⁰⁴), wherein R¹⁰² to R¹⁰⁴ are independently a C1 to C10 alkyl group), an amidino group, a hydrazine group, a hydrazone group, a carboxyl group, a C1 to C30 alkyl group, a C1 to C30 alkylsilyl group, a C3 to C30 cycloalkyl group, a C2 to C30 heterocycloalkyl group, a C6 to C30 aryl group, a C2 to C30 heteroaryl group, a C1 to C30 alkoxy group, a C1 to C30 fluoroalkyl group, or an *-L¹-A group (wherein L¹ is a linking group and A is the arm), provided that at least one group represented by R is an *-L¹-A group.

The L¹ is a linking group of the core and arm (A). The L¹ may be, for example, a single bond, —O—, —OOC—, —COO—, —OCOO—, —NW— (W is hydrogen or a C1-C10 alkyl group), —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 an alkylarylene group, a substituted or unsubstituted C2-C30 arylalkylene group, a substituted or unsubstituted silylene group, a substituted or unsubstituted C2-C30 alkenyl group, a substituted or unsubstituted C2-C30 alkynyl group, or a group where at least one group of the foregoing groups is linked together.

In case the polyhedral oligomeric silsesquioxane of the above Chemical Formulas 1 to 6 has the maximum number of arms, all groups represented by R are respectively the *-L¹-A group. For example, Chemical Formula 1 may have a maximum of 6 arms, Chemical Formula 2 may have a maximum of 8 arms, Chemical Formula 3 may have a maximum 10 of arms, Chemical Formula 4 may have a maximum of 12 arms, Chemical Formula 5 may have a maximum of 14 arms, and Chemical Formula 6 may have a maximum of 16 arms.

The arm connected to at least one Si atom of the polyhedral oligomeric silsesquioxane may include a vinyl-based first structural unit including at least one ethylene oxide group at the side chain, and an oleophobic vinyl-based second structural unit.

The arm may be formed by copolymerization of the first structural unit and the second structural unit, in the form of, for example, a block copolymer, an alternating copolymer, a random copolymer, a graft copolymer, and the like.

The first structural unit may be represented by the following Chemical Formula 7.

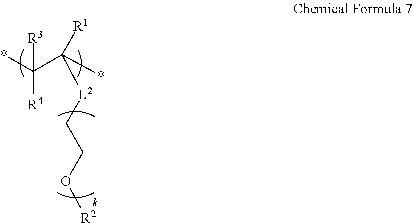

In the above Chemical Formula 7, L² is a single bond, —O—, —OOC—, —COO—, —OCOO—, —NHCO—, —CONH—, —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 an alkylarylene group, a substituted or unsubstituted C2-C30 arylalkylene group, or a group where at least one group of the foregoing groups is linked together. R¹, R², R³, and R⁴ are independently hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, or a substituted or unsubstituted C2-C30 arylalkyl group. K is an integer ranging from 1 to 500 (e.g., 3 to 250, or 5 to 100).

The vinyl-based first structural unit including the side chain with at least one ethylene oxide group may be, for example, an acrylate-based structural unit as follows.

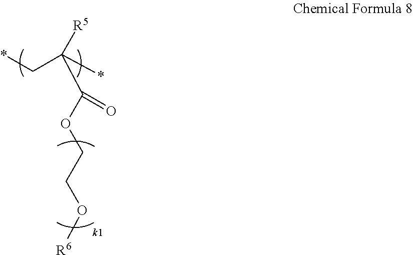

In the above Chemical Formula 8, R⁵ and R⁶ are each independently hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, or a substituted or unsubstituted C2-C30 arylalkyl group, and k1 is an integer ranging from 1 to 500 (e.g., 3 to 250, or 5 to 100).

The first structural unit may include an ethylene oxide group at the side chain. The number of ethylene oxide groups may be increased to extend in a side chain direction of the arm, such that the organic/inorganic composite compound for fouling resistance may become a comb-shaped hydrophilic polymer. For example, even if the same amount of oxygen is included when forming a membrane, the ethylene oxide group is more exposed on the surface of a comb-shaped polymer. Thus, oxygen content on the surface of the comb-shaped polymer may be increased. When the oxygen content on the surface increases, the possibility of forming a hydration surface or a hydration barrier may increase.

One arm in the organic/inorganic composite compound for fouling resistance may include a plurality of the first structural units having different k values, and one arm may have an average k value of Chemical Formula 7 of about 5 to about 100. For example, when the average k value is about 5 to about 100, the hydrophilicity and fouling resistance of the organic/inorganic composite compound for fouling resistance, and the polymerization degree of the arm, may be suitable for use in a membrane for water treatment.

The ethylene oxide group imparts hydrophilicity and fouling resistance to the organic/inorganic composite compound for fouling resistance. Because the ethylene oxide group may inhibit adsorption of, for example, a protein (and/or the like), it has an excellent anti-bio-fouling effect.

When the organic/inorganic composite compound for fouling resistance has arms connected in a star shape, the surface content of the ethylene oxide group may be further increased to further increase the fouling resistance effect. For example, the organic/inorganic composite compound for fouling resistance may have 1 to 16 arms. The organic/inorganic composite compound for fouling resistance having the above number range of the arms may properly manifest the fouling resistance effect for bio-fouling.

The oleophobic vinyl-based second structural unit may include a vinyl-based structural unit including at least one silicon at the side chain. The organic/inorganic composite compound for fouling resistance has oleophobicity due to the second structural unit including the oleophobic silicon side chain group in the arm, which provides the compound with fouling resistance characteristics for preventing oil fouling (or, bio fouling).

The silicon group in the side chain of the oleophobic vinyl-based second structural unit may include, for example, at least one selected from a silane group, a siloxane group, and a combination thereof.

The second structural unit may be represented by the following Chemical Formula 9.

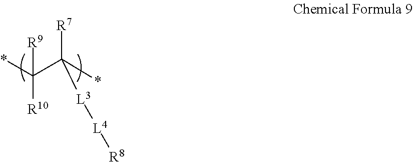

In the above Chemical Formula 9, R⁷, R⁹, and R¹⁰ are each independently hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, or a substituted or unsubstituted C2-C30 arylalkyl group. L³ is a single bond, —O—, —OOC—, —COO—, —OCOO—, —NHCO—, —CONH—, —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 alkylarylene group, a substituted or unsubstituted C2-C30 arylalkylene group, or a group where at least one group of the foregoing groups is linked together. L⁴ is a linking group for linking the oleophobic functional group, R⁸. L⁴ is a single bond, —O—, —OOC—, —COO—, —OCOO—, —NHCO—, —CONH—, —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 alkylarylene group, a substituted or unsubstituted C2-C30 arylalkylene group, or a group where at least one group of the foregoing groups is linked together.

R⁸ may be one of groups represented by the following Chemical Formulas 10 to 15.

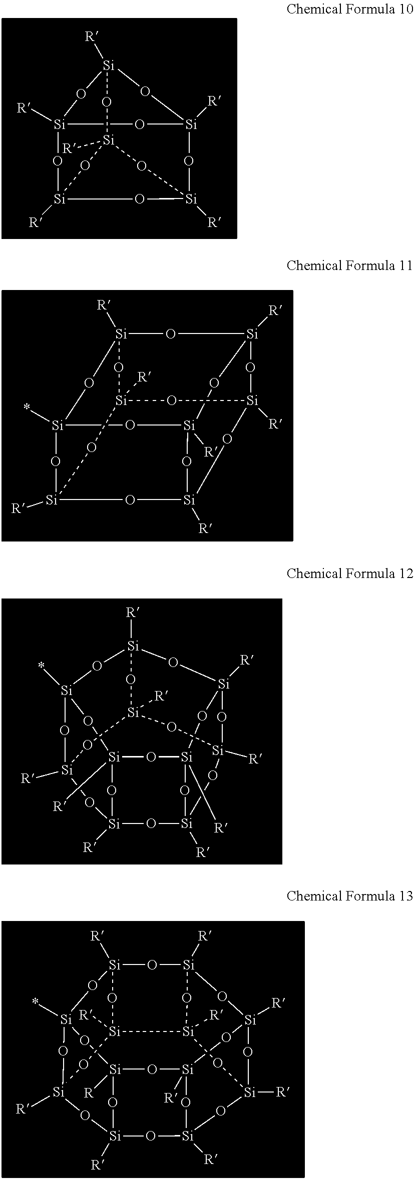

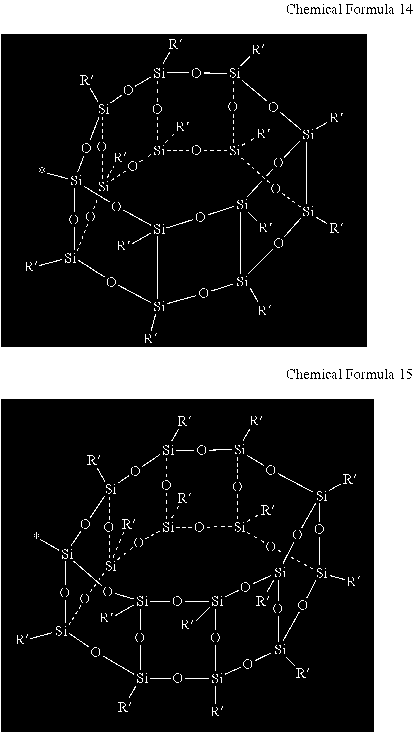

In the above Chemical Formulas 10 to 15, R′ are the same or different, and are independently hydrogen, a hydroxy group, a nitro group, a cyano group, an imino group (═NH, ═NR¹⁰¹, wherein R¹⁰¹ is a C1 to C10 alkyl group), an amino group (—NH₂, —NH(R¹⁰²), —N(R¹⁰³)(R¹⁰⁴), wherein R¹⁰² to R¹⁰⁴ are independently a C1 to C10 alkyl group), an amidino group, a hydrazine group, a hydrazone group, a carboxyl group, a C1 to C30 alkyl group, a C1 to C30 alkylsilyl group, a C3 to C30 cycloalkyl group, a C2 to C30 heterocycloalkyl group, a C6 to C30 aryl group, C2 to C30 heteroaryl group, C1 to C30 alkoxy group, or a C1 to C30 fluoroalkyl group.

As described above, the organic/inorganic composite compound for fouling resistance implements (or imparts) anti-bio-fouling characteristics and oil fouling inhibition characteristics, and thus provides excellent fouling resistance characteristics due to the first structural unit and the second structural unit.

The molar ratio of the first structural unit and the second structural unit in one arm may range from about 1 mol %: about 99 mol % to about 99 mol %: about 1 mol % (e.g., about 50 mol %: about 50 mol % to about 97 mol %: about 3 mol %). When the first structural unit and the second structural unit are included in the ratio of about 76 mol %: about 24 mol % to about 94 mol %: about 6 mol %, the organic/inorganic composite compound for fouling resistance may have characteristics of a water-insoluble property, and excellent fouling resistance (i.e., anti-bio-fouling and oil fouling inhibition) making the organic/inorganic composite compound suitable for use as a membrane in a water treatment.

The organic/inorganic composite compound for fouling resistance includes the first structural unit and the second structural unit at an appropriate ratio, which may provide the compound with water-insoluble properties while having solubility for a desired solvent. Thus, it may be used for the preparation of a membrane for water treatment.

For example, the organic/inorganic composite compound for fouling resistance may be water-insoluble, while it may be dissolved in at least one organic solvent of acetone, acids (e.g., acetic acid, trifluoroacetic acid (TFA), and the like), alcohols (e.g., methanol, isopropanol, 1-methoxy-2-propanol, ethanol, terpineol, and the like), oxygen-containing cyclic compounds (e.g., tetrahydrofuran (THF), 1,4-dioxane, and the like), aromatic compounds including a heteroatom of N, O, or S (e.g., pyridine and the like), halogen compounds (e.g., chloroform, methylene chloride, and the like), aprotic polar compounds (e.g., dimethyl formamide (DMF), dimethyl acetamide (DMAC), dimethyl sulfoxide (DMSO), N-methyl-2-pyrrolidone (NMP), and the like), and acetates (e.g., 2-butoxyethylacetate, 2-(2-butoxyethoxy)ethylacetate, and the like). The organic/inorganic composite compound for fouling resistance should be water-insoluble in order to be used for a membrane for water treatment, and it should be soluble in desired organic solvents in order to manufacture a membrane. These characteristics may be provided by controlling the structure of the arms including the first structural unit and the second structural unit as explained above.

The organic/inorganic composite compound for fouling resistance may also have good hydrophilicity, and thus may be used for preparation of a membrane for water treatment.

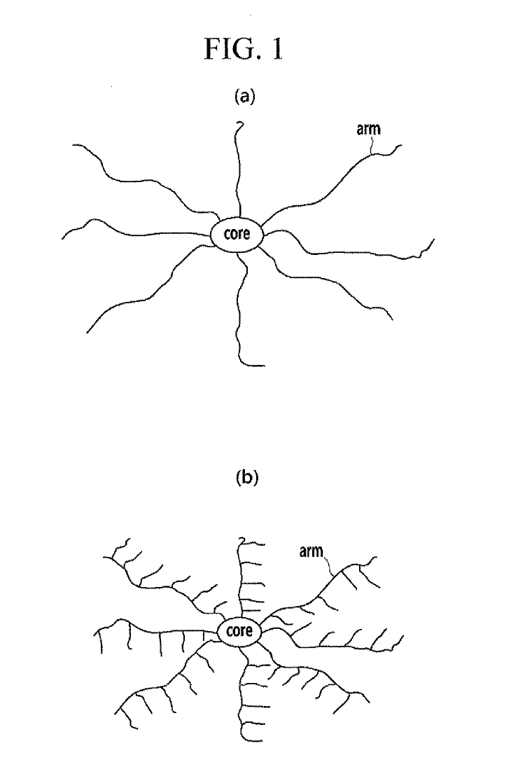

FIG. 1 (a) is a schematic view of one example wherein the organic/inorganic composite compound for fouling resistance has a star shape, and FIG. 1 (b) is a schematic view of one example wherein the ethylene oxide groups included in the side chain of the arm are formed in a comb shape.

The organic/inorganic composite compound for fouling resistance has a core formed of a polyhedron of polyhedral oligomeric silsesquioxane, but is not limited thereto. The core may be in the form of an inorganic oxide, and the arm may be connected through a linking group. The inorganic oxide may include, for example, silica, titania, alumina, zirconia, yttria, chromium oxide, zinc oxide, iron oxide, clay, zeolite, and the like, but is not limited thereto.

A membrane with fouling resistance according to example embodiments includes a surface layer including the organic/inorganic composite compound for fouling resistance.

The membrane with fouling resistance is imparted with the fouling resistance characteristic by forming a surface layer including the organic/inorganic composite compound for fouling resistance on a membrane requiring the fouling resistance characteristic. The membrane with fouling resistance has an excellent effect of preventing the formation of biofilm and oil film, and thus it achieves the desired fouling resistance performance, thereby extending the life-span of the membrane, decreasing the number of washings, and reducing operation energy consumption.

Because the fouling-resist composite compound included in the membrane with fouling resistance has a structure including an ethylene oxide group in a side chain of an arm as described above, the hydrophilicity of the member improves such that the membrane can be effectively used for water treatment. The hydrophilicity may be measured by a contact angle. The hydrophilicity is increased as the contact angle is decreased. The membrane with fouling resistance may have a contact angle of, for example, about 10 to about 90 degrees. For example, the membrane with fouling resistance may have a contact angle of about 20 to about 80 degrees, or of about 30 to about 70 degrees.

The shape and the kind of the membrane are not limited, and any membrane formed by a known method using a known material may be used. Such a membrane may be used as an inner layer, and a surface layer including the organic/inorganic composite compound for fouling resistance may be formed on the surface to manufacture the membrane with fouling resistance.

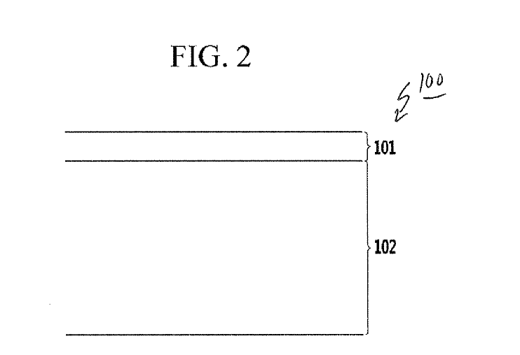

FIG. 2 is a schematic view of a membrane with fouling resistance including a surface layer and an inner layer according to example embodiments.

Referring to FIG. 2, a membrane 100 includes a surface layer 101 on a surface of an inner layer 102. The surface layer 101 may have a thickness of about 0.01 μm to about 100 μm (e.g., about 0.02 μm to about 50 μm). When the surface layer 101 has a thickness of about 0.03 μm to about 25 μm, fouling resistance may be properly implemented.

The inner layer 102 may include, for example, at least one compound selected from a polyacrylate-based compound, a polymethacrylate-based compound, a polystyrene-based compound, a polycarbonate-based compound, a polyethylene terephthalate-based compound, a polyimide-based compound, a polybenzimidazole-based compound, a polybenzthiazole-based compound, a polybenzoxazole-based compound, a polyepoxy resin compound, a polyolefin-based compound, a polyphenylene vinylene compound, a polyamide-based compound, a polyacrylonitrile-based compound, a polysulfone-based compound, a cellulose-based compound, polyvinylidene fluoride (PVDF), polytetrafluoroethylene (PTFE), a polyvinyl chloride (PVC) compound and combinations thereof.

The surface layer 101 may be formed by any known method, and the method is not specifically limited. For example, a process such as solvent casting, spin casting, wet spinning, dry spinning, and the like may be used, and melt processing such as injection, melt spinning, and the like may be applied. Specifically, in the case of solvent casting, a solution including the organic/inorganic composite compound for fouling resistance dissolved in a solvent is prepared, coated on the surface of a preliminary membrane that will become the inner layer 102, and then dried to manufacture a membrane with fouling resistance. The concentration of the solution may be about 0.1 to about 50 wt %.

The surface layer 101 formed by the above method may be a continuous coating layer, or a discontinuous coating layer.

Specifically, the membrane with fouling resistance may be a membrane for water treatment (e.g., a separation membrane for water treatment). The separation membrane for water treatment may be a microfiltration membrane, an ultrafiltration membrane, a nanofiltration membrane, a reverse osmotic membrane, or a forward osmotic membrane according to use, and it may be divided (or configured) according to the size of particles to be separated. A method of preparing the separation membrane is not limited, and the membrane may be manufactured by known methods while controlling the pore size, the pore structure, and the like.

The membrane with fouling resistance may be a separation membrane for water treatment, wherein the inner layer is a microfiltration membrane, an ultrafiltration membrane, a nanofiltration membrane, a reverse osmotic membrane, or a forward osmotic membrane. Further, for example, the inner layer may be a single membrane formed of a homogeneous material, or a composite membrane including a plurality of layers formed of a heterogeneous material.

In the case that the membrane with fouling resistance is a separation membrane for water treatment, the inner membrane may include pores, and the organic/inorganic composite compound for fouling resistance may penetrate into the pores exposed on the surface of the inner membrane when coating a surface layer.

In the case that the membrane with fouling resistance is a separation membrane for water treatment, it may be used for various water treatment devices, (e.g., a water treatment device of a reverse osmosis type, a water treatment device of a forward osmosis type, and the like), but is not limited thereto.

The water treatment device may be applied to water purification, wastewater treatment and reuse, seawater desalination, oil separation, food processing, and the like.

Hereinafter, the embodiments are illustrated in more detail with reference to examples. However, the following are example embodiments and are not limiting.

### EXAMPLES

### Precursor Synthesis

### 1) Synthesis of octakis(3-hydroxypropyldimethylsiloxy)octasilsesquioxane (OHPS)

About 0.5 g of octakis(hydrodimethylsiloxy)octasilsesquioxane (commercially available reagent, see the following Chemical Formula 16) is put in a 50 ml round-bottomed flask and dissolved in about 6 ml of toluene, and then about 0.34 ml of allyl alcohol is added thereto. Then, platinum(0)-1,3-divinyl-1,1,3,3-tetramethyldisiloxane (a 2 wt % Pt/xylene solution) is injected using a syringe, while agitating the reaction solution at about 25 CC under a nitrogen atmosphere. After reacting for 1 hour, toluene and unreacted allyl alcohol are removed with a rotary evaporator. The obtained material is dried in a vacuum oven at about 35° C. for an additional 12 hours to obtain about 0.748 g of brown solid OHPS (see the following Chemical Formula 17).

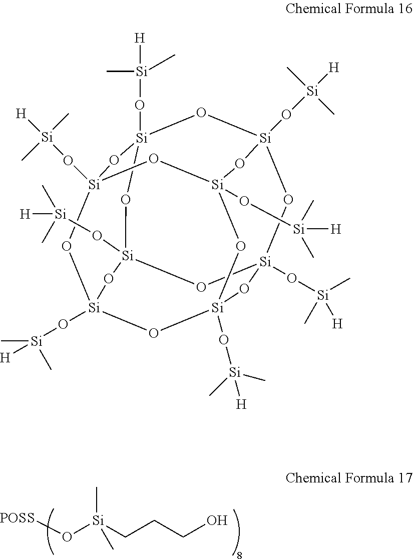

The above Chemical Formula 17 represents a form where 8 H atoms are substituted by —(CH₂)₃—OH groups in Chemical Formula 16, wherein POSS is an abbreviation of polyhedral oligomeric silsesquioxane.

### 2) Synthesis of octakis(bromodimethylesterpropyldimethylsiloxy)octasilsesquioxane (OBPS)

About 0.745 g of OHPS is put in a 100 ml round-bottomed flask and dissolved in about 15 ml of dichloromethane, and then cooled to about 0° C. using ice water. Then, about 1.14 ml of triethylamine is injected and sufficiently agitated. Subsequently, about 1.014 ml of 2-bromoisobutyryl bromide is dripped therein. After the injection is completed, the reaction solution is agitated at room temperature for about 12 hours. The product is dissolved in about 100 ml of dichloromethane, and then moved to a 500 ml separatory funnel and extracted twice with about 100 ml of distilled water to remove salts produced as a by-product. Water is removed from the dichloromethane layer using MgSO₄, and then a solid phase is filtered and the solvent is removed with a rotary evaporator. The obtained material is purified by column chromatography (mobile phase EA:Hexane=1:3 (volume ratio)) to obtain a final product of about 1.06 g of OBPS (see the following Chemical Formula 18).

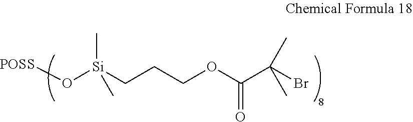

In the above Chemical Formula 18, POSS is the same as defined in Chemical Formula 17.

### Synthesis of Organic/Inorganic Composite Compound for Fouling Resistance Using OBPS

### Example 1

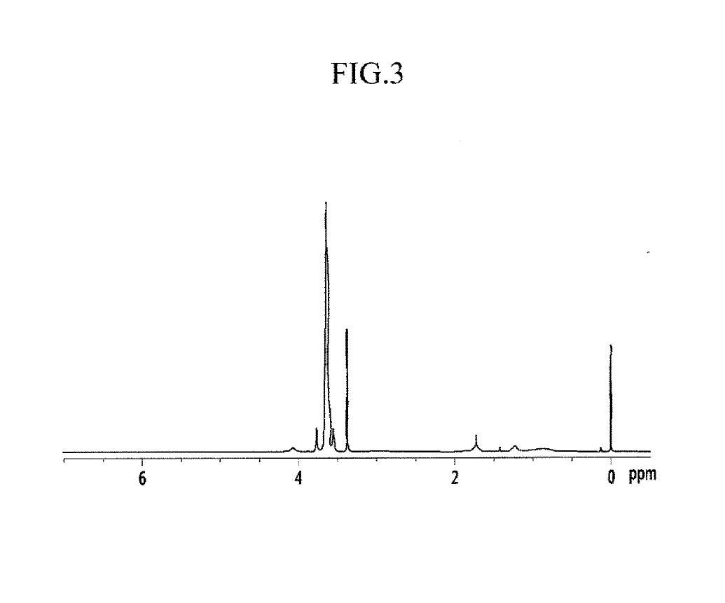

Using OBPS as 8-armed initiator, an organic/inorganic composite compound for fouling resistance (referred to as “SPP#,” where “#” indicates the relative mole ratio of PEGMA in the first structural unit (PEGMA) and the second structural unit (POSSMA)) is synthesized according to the atom transfer radical polymerization. First, about 0.041 g of OBPS and about 7 g of polyethylene glycol monomethylethermethacrylate (Mn-475, PEGMA), about 0.87 g of cyclohexyl polyhedron oligomer silsesquioxane propylmethacrylate (POSSMA), and about 13 ml of toluene are introduced into a 100 ml Schlenk flask and agitated. A FPH (freeze-pump-thaw) process is repeated three times to remove oxygen in the reaction solution. Then about 18.2 mg of Cu(I)Br is added while injecting nitrogen, and the FPH process is repeated two times. The reaction flask is displaced in an oil bath at 65° C. and injected with about 26 ul of N,N,N′,N′,N″-pentamethyldiethylenetriamine (PMDETA) to initiate the reaction. After agitating for 12 hours, the product is dissolved in about 50 ml of dichloromethane and passed through a column filled with aluminum oxide twice to remove a catalyst. The obtained solution is precipitated in about 400 ml of hexane three times to provide an organic/inorganic composite compound for fouling resistance represented by the following Chemical Formula 19. The organic/inorganic composite compound for fouling resistance represented by the following Chemical Formula 19 is dissolved in CDCl₃ to provide a 1H-NMR spectrum, and the results are shown in FIG. 3. The obtained organic/inorganic composite compound for fouling resistance (SPP94) has a number average molecular weight of about 35,400.

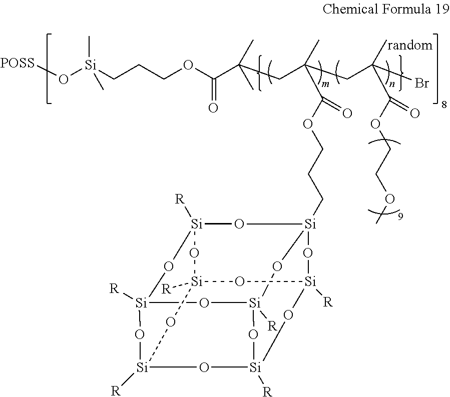

In Chemical Formula 19, POSS is the same as defined in Chemical Formula 17, wherein R is cyclohexyl, m:n is about 6:94, and random means that m-repeated structural units and n-repeated structural units are copolymerized as a random copolymer.

### Example 2

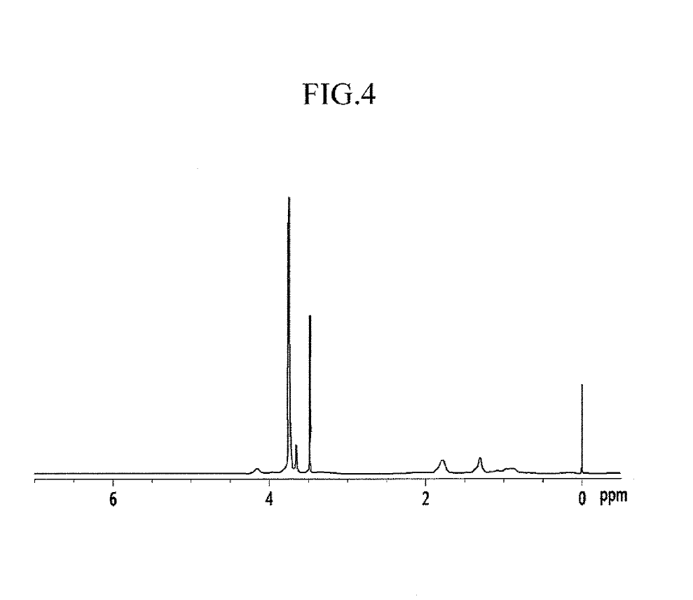

An organic/inorganic composite compound for fouling resistance (SPP87) is prepared in accordance to substantially the same procedure as in Example 1, except that about 2.92 g of POSSMA, about 7 g of PEGMA, about 20 ml of toluene, about 0.046 g of OBPS, about 20.2 mg of CuBr, and about 29 ul of PMDETA are used, wherein m:n is about 13:87 in Chemical Formula 19. The organic/inorganic composite compound for fouling resistance (SPP87) is dissolved in CDCl₃ to provide a 1H-NMR spectrum, and the results are shown in FIG. 4. It is confirmed that the obtained SPP87 has a number average molecular weight of about 42,700.

### Comparative Example 1

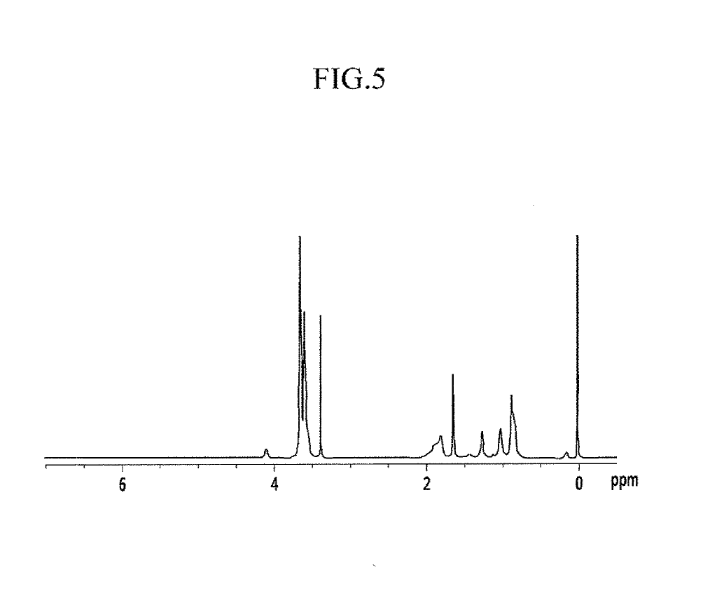

A compound (SPM15) is synthesized in accordance with substantially the same procedure as in Example 1, except that about 2.38 g of PEGMA, about 2.28 g of methylmethacrylate (MMA), about 14.2 ml of anisole, about 0.076 g of OBPS, about 16.6 mg of CuBr, and about 24.0 ul of PMDETA are used. The compound (SPM15) is dissolved in CDCl₃ to provide a ¹H-NMR spectrum, and the results are shown in FIG. 5. It is confirmed that the obtained compound (SPM15) has a number average molecular weight of about 28,200.

### Comparative Example 2

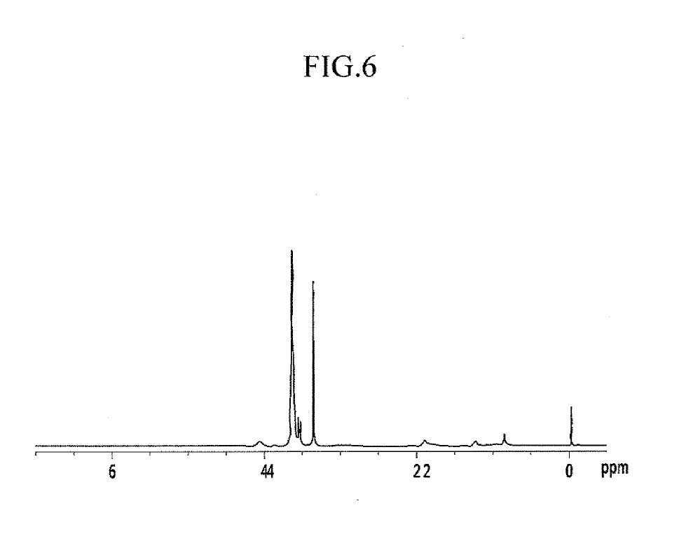

A compound (SP) is synthesized in accordance with the same procedure as in Example 1, except that about 7.2 g of PEGMA, about 8.53 ml of anisole, about 0.046 g of OBPS, about 10.0 mg of CuBr, and about 14.4 ul of PMDETA are used. The compound (SP) is dissolved in CDCl₃ to provide a ¹H-NMR spectrum, and the results are shown in FIG. 6. It is confirmed that the obtained compound (SP) has a number average molecular weight of about 53,500.

### Evaluation of Solubility Characteristics

### Experimental Example 1

Solubility in water of each compound synthesized in Examples 1 to 3 and Comparative Examples 1 and 2 is evaluated, and the results are described in the following Table 1. To evaluate solubility, about 10 mg of each compound synthesized in Examples 1 to 3 and Comparative Examples 1 and 2 is impregnated with about 2 g of a solvent (water) at room temperature for about 24 hours, and allowed to stand. Then, a visual inspection was performed. If the aqueous solution of the compound was a transparent liquid, then the compound was soluble. If precipitation was observed in the aqueous solution of the compound, then the compound was insoluble.

### Experimental Example 2

Solubility of each compound synthesized in the Examples 1 to 3 and Comparative Examples 1 and 2 for methanol is evaluated by a substantially equivalent method as in Experimental Example 1, except for using methanol instead of water, and the results are described in the following Table 1.

TABLE 1

| | MOLE RATIO (PEGMA:POSSMA; PEGMA:MMA | | | |
|---|---|---|---|---|
| | IN COMPARATIVE EXAMPLE 1) | | | |
| | AMOUNT DURING | MOLE RATIO OF | | |
| | SYNTHESIS | SYNTHESIZED ARM IN | SOLUBILITY IN | SOLUBILITY IN |
| | (MOL/MOL) | POLYMER (MOL/MOL) | WATER | METHANOL |
| EXAMPLE 1 | 92:8 | 94:6 | insoluble | soluble |
| SPP94 | | | | |
| EXAMPLE 2 | 81:19 | 87:13 | insoluble | soluble |
| SPP87 | | | | |
| COMPARATIVE | 18:82 | 15:85 | insoluble | soluble |
| EXAMPLE 1 | | | | |
| SPM15 | | | | |
| COMPARATIVE | 100:0 | 100:0 | soluble | soluble |
| EXAMPLE 2(SP) | | | | |

Fabrication of Membrane with Fouling Resistance

Each of the organic/inorganic composite compound for fouling resistance (SPP94) obtained from Example 1, the organic/inorganic composite compound for fouling resistance (SPP87) obtained Example 2, and the compound (SPM15) obtained from Comparative Example 1 is dissolved in methanol to provide a solution. Then, the solution is coated on the surface of a commercially available polysulfone membrane by spin coating to provide a surface layer. Thereby, a membrane with fouling resistance including the surface layer and the inner layer (polysulfone) is obtained. The spin coating conditions are set as 1 wt % of sample concentration, 1000 rpm, and 60 seconds.

Evaluation of Surface Morphology of Membrane with Fouling Resistance

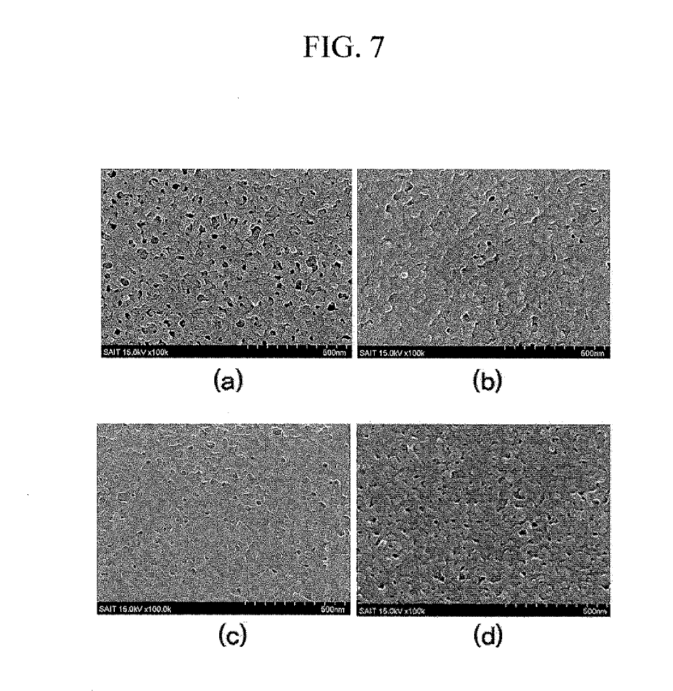

In order to observe the change in the surface morphology of before and after forming a surface layer of a membrane with fouling resistance, the organic/inorganic composite compound for fouling resistance (SPP94) according to Example 1, the organic/inorganic composite compound for fouling resistance (SPP87) according to Example 2, and the compound (SPM15) according to Comparative Example 1 are respectively coated on a polysulfone membrane surface to provide a membrane with fouling resistance, and the surface of the membrane with fouling resistance is observed by a scanning electron microscope (SEM) and is shown in FIG. 7.

FIGS. 7(a), 7(b), 7(c) and 7(d) show scanning electron microscope photographs of the membranes with fouling resistance manufactured so as to form a surface layer including the compounds synthesized in Example 1, Example 2 and Comparative Example 1.

FIG. 7 (a) magnifies the morphology structure of commercially available ultrafiltration polysulfone layer by 100,000 times; and FIGS. 7 (b), 7 (c), and 7 (d) are scanning electron microscope photographs magnifying the cross-section of the membrane with fouling resistance obtained by coating SPP94 according to Example 1, SPP87 according to Example 2, and SPM15 according to Comparative Example 1 on the commercially available ultrafiltration polysulfone layer of FIG. 7 (a) by 100,000 times.

As shown in FIG. 7, it is confirmed that the pore size is maintained as the size of the ultrafiltration membrane, and a significant difference of shapes between the membranes with fouling resistance is not found.

### Measurement of Contact Angle

The membranes with fouling resistance obtained by using the ultrafiltration polysulfone layer and SPP94 of Example 1, SPP87 of Example 2, and SPM15 of Comparative Example 1 are measured for contact angle. After dripping one drop of water on the each layer, the contact angle is measured immediately, after 60 seconds, after 90 seconds, and after 120 seconds, and the results are shown in the following Table 2.

TABLE 2

| | CONTACT ANGLE ACCORDING TO TIME LAPSE (UNIT: DEGREE) | | | |
|---|---|---|---|---|
| | 0 SECOND | 60 SECONDS | 90 SECONDS | 120 SECONDS |
| ULTRAFILTRATION MEMBRANE | 72 | 72 | 72 | 72 |
| (POLYSULFONE) | | | | |
| MEMBRANE WITH FOULING RESISTANCE | 70 | 61 | 57 | 54 |
| COATED WITH SPP94 (EXAMPLE 1) | | | | |
| MEMBRANE WITH FOULING RESISTANCE | 70 | 63 | 59 | 55 |
| COATED WITH SPP87 (EXAMPLE 2) | | | | |
| MEMBRANE WITH FOULING RESISTANCE | 71 | 66 | 61 | 55 |
| COATED WITH SPM15 (COMPARATIVE | | | | |
| EXAMPLE 1) | | | | |

### Measurement of Pure Water Permeation Rate

To determine performance of the ultrafiltration membranes prepared above, the pure water permeation rate is measured and the results are described in the following Table 3. First, each membrane with fouling resistance is located on a cell having an effective area of about 41.8 cm² for measurement and then compacted under pressure of about 2 Kg/cm² for about 2 hours, and is measured under pressure of about 1 Kg/cm². The permeation rate is calculated by the following equation:

F=V/(A×t)

wherein V denotes the permeation rate, A denotes the area of the membrane, and t denotes the operation time.

TABLE 3

| | | PURE WATER |
|---|---|---|
| | COAT | PERMEATION |
| | CONDITIONS | RATE (LMH) |
| ULTRAFILTRATION MEMBRANE | — | 530 |
| (POLYSULFONE) | | |
| ULTRAFILTRATION MEMBRANE | 1 wt %, 1000 | 490 |
| COATED WITH SPP94 | rpm, 60 s | |
| (EXAMPLE 1) | | |
| ULTRAFILTRATION MEMBRANE | 1 wt %, 1000 | 480 |
| COATED WITH SPP87 | rpm, 60 s | |
| (EXAMPLE 2) | | |
| ULTRAFILTRATION MEMBRANE | 1 wt %, 1000 | 490 |
| COATED SPM15 | rpm, 60 s | |
| (COMPARATIVE EXAMPLE 1) | | |

The LMH denotes the amount of passing water per unit hour, the L denotes the amount of water passing through the membrane (liter), the M denotes the area of the membrane (m²), and the H denotes passing time (hours). That is, it is an evaluation unit for how many liters of water pass through the membrane area of about 1 m² in about 1 hour. As shown in Table 3, it is confirmed that the pure water permeation rate is reduced by about 7.5%, about 9.4%, about 7.5% compared to the polysulfone ultrafiltration membrane before the coating when the membrane is coated with about 1 wt % of the SPP94 (Example 1) methanol solution, about 1 wt % of the SPP87 (Example 2) methanol solution, and about 1 wt % of the SPM15 (Comparative Example 1) methanol solution, so the water permeability is insignificantly deteriorated by coating.

Measurement and Evaluation of Surface Chemical Composition XPS of Membrane with Fouling Resistance

The surfaces of membranes with fouling resistance obtained by using the organic/inorganic composite compound for fouling resistance (SPP94) according to Example 1 and the organic/inorganic composite compound for fouling resistance (SPP87) according to Example 2 are analyzed by X-ray photoelectron spectroscopy (XPS), and the results are shown in the following Table 4. The peak intensity of element measured by XPS, and the atomic ratios of O (oxygen)/C (carbon) and Si (silicon)/C (carbon) are calculated and are shown in the following Table 4.

TABLE 4

| | C 1S | O 1S | SI 2P | S 2P | O/C | SI/C |
|---|---|---|---|---|---|---|
| ULTRAFILTRATION | 85.21 | 12.85 | — | 1.94 | 0.15 | — |
| MEMBRANE | | | | | | |
| (POLYSULFONE) | | | | | | |
| MEMBRANE WITH | 67.55 | 27.77 | 4.68 | — | 0.41 | 0.069 |
| FOULING RESISTANCE | | | | | | |
| COATED WITH SPP94 | | | | | | |
| (EXAMPLE 1) | | | | | | |
| MEMBRANE WITH | 68.49 | 26.50 | 5.01 | — | 0.39 | 0.073 |
| FOULING RESISTANCE | | | | | | |
| COATED WITH SPP87 | | | | | | |
| (EXAMPLE 2) | | | | | | |
| MEMBRANE WITH | 70.95 | 27.86 | 1.19 | — | 0.39 | 0.017 |
| FOULING RESISTANCE | | | | | | |
| COATED WITH SPM15 | | | | | | |
| (COMPARATIVE | | | | | | |
| EXAMPLE 1) | | | | | | |

From the results of Table 4, it is confirmed that the contents of oxygen (O) and silicon (Si) are high on the surfaces of the membranes with fouling resistance obtained by using SPP94 according to Example 1 and SPP87 according to Example 2.

### Measurement 1 of Fouling Resistance (Anti-Bio-Fouling Characteristic)

A permeation rate is measured to determine the fouling resistance performance of the membrane with fouling resistance obtained by using the organic/inorganic composite compound for fouling resistance (SPP94) according to Example 1, the organic/inorganic composite compound for fouling resistance (SPP87) according to Example 2, and the compound (SPM15) according to Comparative Example 1. First, the membrane with fouling resistance is displaced on a measurement cell having an effective area of about 41.8 cm² and measured in a pressure flowing speed of 1 Kg/cm² for 3 hours.

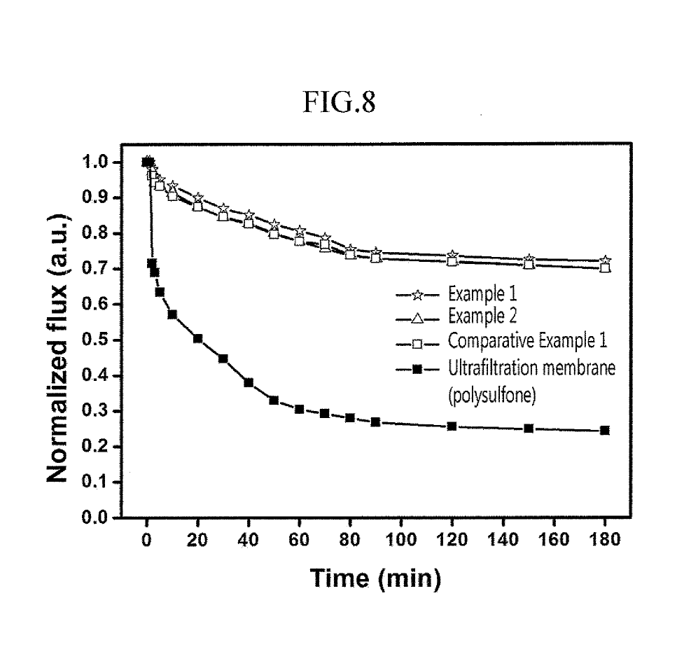

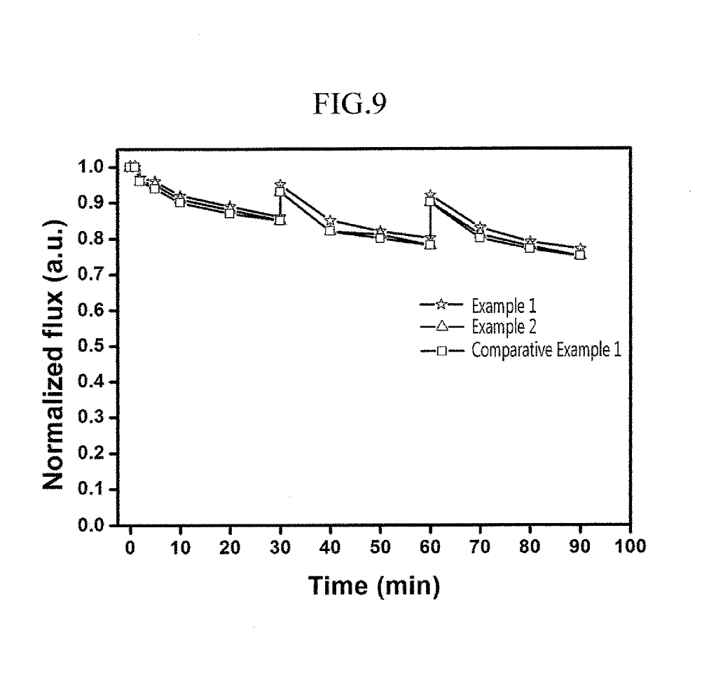

FIG. 8 is a graph showing the change in permeation rate according to the time lapse, and the maintenance ratio of permeation rate after 3 hours is calculated and shown in the following Table 3. FIG. 9 is a graph showing the change in permeation rate of the membrane with fouling resistance cleaned every 30 minutes according to the time lapse, and the permeation rate recovery ratios after 30 minutes and 60 minutes are calculated and are shown in the following Table 5.

The fouling test material is bovine serum albumin (BSA) protein having a concentration of about 1.0 mg/mL in about 0.1 M phosphate buffered saline (PBS) solution.

TABLE 5

| | | RECOVERY RATIO | RECOVERY RATIO |
|---|---|---|---|
| | MAINTENANCE RATIO | OF PERMEATION RATE | OF PERMEATION RATE |
| | OF PERMEATION RATE | AFTER 30 MINUTES | AFTER 60 MINUTES |
| | (%) AFTER 3 HOURS | POST-CLEANING (%) | POST-CLEANING (%) |
| ULTRAFILTRATION MEMBRANE | 24 | — | — |
| (POLYSULFONE) | | | |
| MEMBRANE WITH FOULING | 72 | 95 | 92 |
| RESISTANCE COATED WITH SPP94 | | | |
| (EXAMPLE 1) | | | |
| MEMBRANE WITH FOULING | 69 | 93 | 90 |
| RESISTANCE COATED WITH SPP87 | | | |
| (EXAMPLE 2) | | | |
| MEMBRANE WITH FOULING | 69 | 93 | 90 |
| RESISTANCE COATED WITH SPM15 | | | |
| (COMPARATIVE EXAMPLE 1) | | | |

As shown in Table 5, the maintenance ratio of permeation rate is maintained at about 24%, about 72%, about 69%, and about 69%, respectively, before coating the ultrafiltration membrane, or when coated with SPP94 (Example 1), SPP87 (Example 2), and SPM15 solutions (Comparative Example 1). SPP94 (Example 1), SPP87 (Example 2), and SPM15 (Comparative Example 2) have similar resistance to the bio-fouling.

### Measurement Test 2 of Fouling Resistance (Anti-Oil-Fouling Characteristics)

The permeation rate is measured to determine the fouling resistance performance of membranes with fouling resistance obtained by using the organic/inorganic composite compound for fouling resistance (SPP94) according to Example 1, the organic/inorganic composite compound for fouling resistance (SPP87) according to Example 2, and the compound (SPM15) according to Comparative Example 1. First, each membrane with fouling resistance is displace on a measurement cell having an effective area of about 41.8 cm² and measured in a pressure flowing speed of about 1 Kg/cm² for 3 hours.

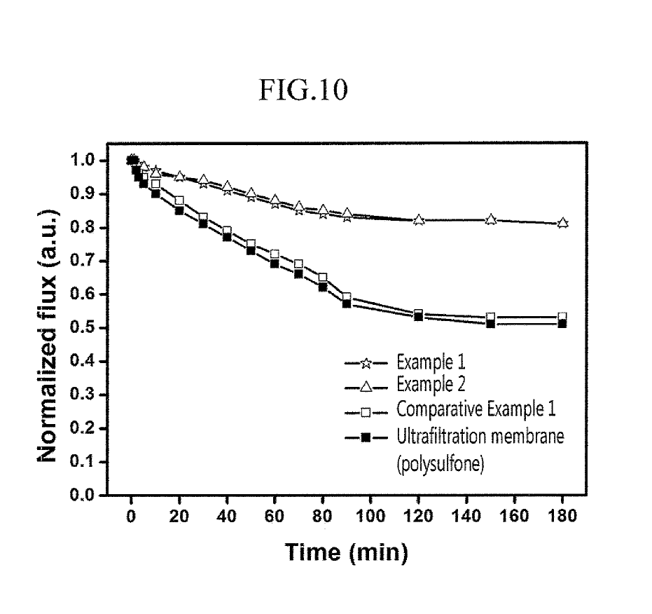

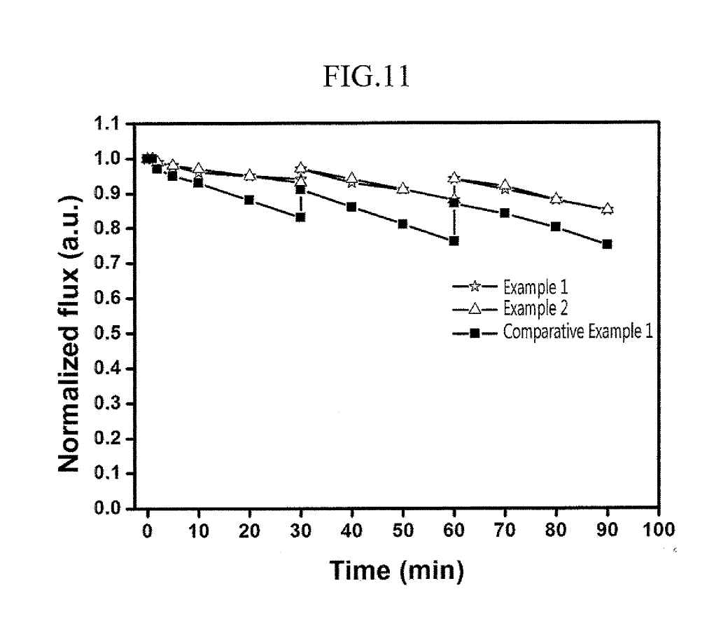

FIG. 10 is a graph showing the change in permeation rate according to the time lapse, and the maintenance ratio of permeation rate after three hours is calculated and is shown in the following Table 6. FIG. 11 is a graph showing the change in permeation rate of the membrane with fouling resistance that is cleaned every 30 minutes according to the time lapse, and the recovery ratio of the permeation rate after 30 minutes and 60 minutes are calculated and are shown in the following Table 6.

The fouling test material is a vacuum pump oil having a concentration of about 0.9 mg/mL in a distilled water solution, and the surfactant is sodium dodecyl sulfate (SDS) having a concentration of about 0.1 mg/mL.

TABLE 6

| | | RECOVERY RATIO | RECOVERY RATIO |
|---|---|---|---|
| | MAINTENANCE RATIO | OF PERMEATION RATE | OF PERMEATION RATE |
| | OF PERMEATION RATE | AFTER 30 MINUTES | AFTER 60 MINUTES |
| | AFTER 3 HOURS (%) | POST-CLEANING (%) | POST-CLEANING (%) |
| ULTRAFILTRATION MEMBRANE | 51 | — | — |
| (POLYSULFONE) | | | |
| MEMBRANE WITH FOULING | 81 | 97 | 94 |
| RESISTANCE COATED WITH SPP94 | | | |
| (EXAMPLE 1) | | | |
| MEMBRANE WITH FOULING | 81 | 97 | 94 |
| RESISTANCE COATED WITH SPP87 | | | |
| (EXAMPLE 2) | | | |
| MEMBRANE WITH FOULING | 53 | 91 | 87 |
| RESISTANCE COATED WITH SPM15 | | | |
| (COMPARATIVE EXAMPLE 1) | | | |

As shown in Table 6, the maintenance ratio of the permeation rate is maintained at about 51%, about 81%, about 81%, and about 53%, respectively, before coating the ultrafiltration membrane or when coating with the SPP94 (Example 1), SPP87 (Example 2), and SPM15 (Comparative Example 1) solutions. SPP94 (Example 1) and SPP87 (Example 2) have superior resistance to oil fouling than SPM15 (Comparative Example 2).

When simultaneously evaluating the results of Table 3 and Table 4, Example 1 and Example 2 show excellent fouling resistance in the view of showing high resistance to both bio-fouling and oil fouling.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

| | |
|---|---|
| 100: membrane | 101: surface layer |
| 102: inner layer | |

What is claimed is:

1. An organic/inorganic fouling resistant composite compound, comprising:
a core of a polyhedron of a polyhedral oligomeric silsesquioxane; and
at least one arm connected to an silicon (Si) atom of the polyhedral oligomeric silsesquioxane,
wherein the at least one arm includes a vinyl-based first structural unit and an oleophobic vinyl-based second structural unit,
the vinyl-based first structural unit includes at least one ethylene oxide group at a side chain of the vinyl-based first structural unit, and
the oleophobic vinyl-based second structural unit includes a silicon group at the side chain.

2. The organic/inorganic fouling resistant composite compound of claim 1, wherein an atomic ratio of silicon (Si) to oxygen (O) in the polyhedron of the polyhedral oligomeric silsesquioxane is about 1:1 to 3/2.

3. The organic/inorganic fouling resistant composite compound of claim 1, wherein the polyhedron of the polyhedral oligomeric silsesquioxane is one selected from a pentahedron of the following Chemical Formula 1, a hexahedron of the following Chemical Formula 2, a heptahedron of the following Chemical Formula 3, an octahedron of the following Chemical Formula 4, an enneahedron of the following Chemical Formula 5, a decahedron of the following Chemical Formula 6, and derivatives thereof: 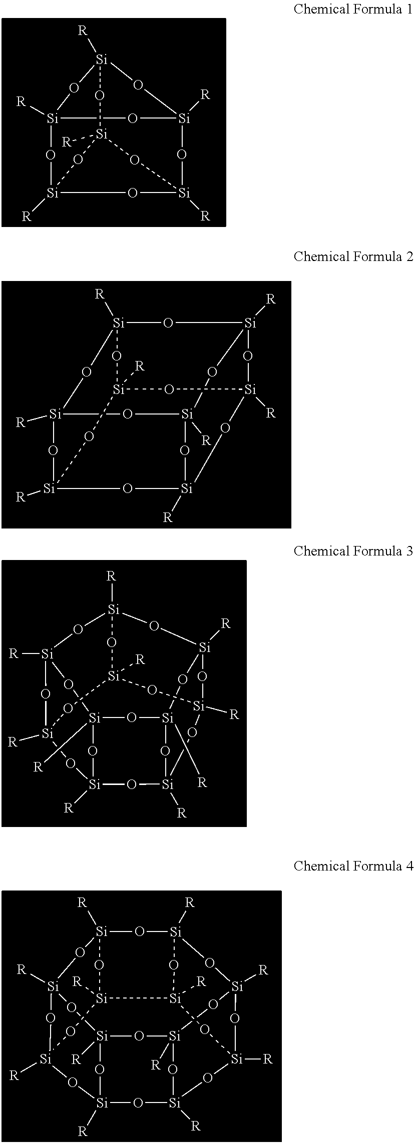 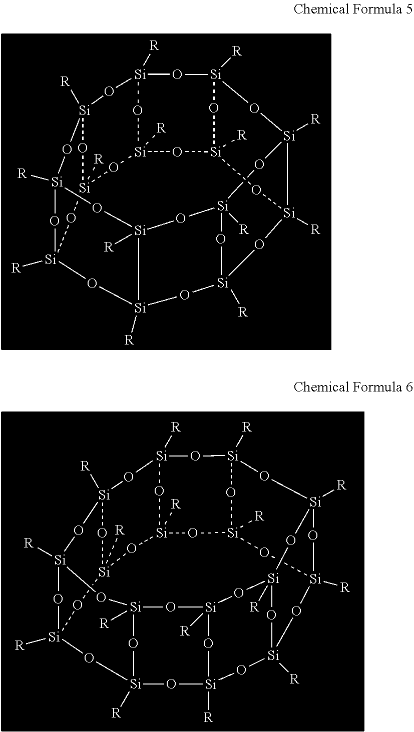
wherein, in Chemical Formulas 1 to 6, groups represented by R's are the same or different, and are each independently one selected from hydrogen, a hydroxy group, a nitro group, a cyano group, an imino group (═NH, ═NR¹⁰¹, wherein R¹⁰¹ is a C1 to C10 alkyl group), an amino group (—NH₂, —NH(R¹⁰²), —N(R¹⁰³)(R¹⁰⁴), wherein R¹⁰² to R¹⁰⁴ are each independently C1 to C10 alkyl group), an amidino group, a hydrazine group, a hydrazone group, a carboxyl group, a C1 to C30 alkyl group, a C1 to C30 alkylsilyl group, a C3 to C30 cycloalkyl group, a C2 to C30 heterocycloalkyl group, a C6 to C30 aryl group, a C2 to C30 heteroaryl group, a C1 to C30 alkoxy group, a C1 to C30 fluoroalkyl group, and an *L¹-A group (wherein, L¹ is a linking group, and A is the arm), provided that at least one group represented by R is *-L¹-A group.

4. The organic/inorganic fouling resistant composite compound of claim 3, wherein the polyhedron includes a closed polyhedron having oxygen (O) in at least one —Si—O—Si— bond unsubstituted and connected in the closed polyhedron.

5. The organic/inorganic fouling resistant composite compound of claim 4, wherein the polyhedron further includes an open polyhedron having oxygen (O) in at least one —Si—O—Si— bond substituted with substituents and disconnected in the open polyhedron.

6. The organic/inorganic fouling resistant composite compound of claim 1, wherein the core is connected by 1 to 16 arms.

7. The organic/inorganic fouling resistant composite compound of claim 1, wherein the vinyl-based first structural unit is a structural unit represented by the following Chemical Formula 7: 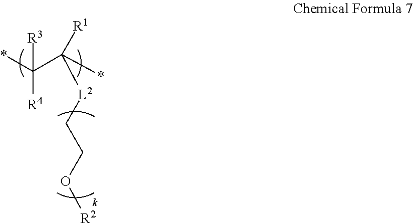
wherein, in the Chemical Formula 7,
L² is one selected from a single bond, —O—, —OOC—, —COO—, —OCOO—, —NHCO—, —CONH—, —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 an alkylarylene group, a substituted or unsubstituted C2-C30 arylalkylene group, and a group where at least one group of the foregoing groups is linked together,
R¹, R², R³, and R⁴ are each independently one selected from hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, and a substituted or unsubstituted C2-C30 arylalkyl group, and
k is an integer ranging from 1 to 500.

8. The organic/inorganic fouling resistant composite compound of claim 7, wherein the average k value of Chemical Formula 7 in the at least one arm is about 5 to about 100.

9. The organic/inorganic fouling resistant composite compound of claim 1, wherein the silicon group of the oleophobic vinyl-based second structural unit includes at least one selected from a silane group, a siloxane group, and a combination thereof.

10. The organic/inorganic fouling resistant composite compound claim 9, wherein the oleophobic vinyl-based second structural unit is a structural unit represented by the following Chemical Formula 9: 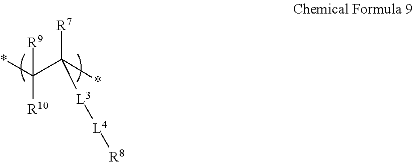
wherein, in the above Chemical Formula 9,
R⁷, R⁹, and R¹⁰ are each independently one selected from hydrogen, a substituted or unsubstituted C1 to C30 alkyl group, a substituted or unsubstituted C5 to C30 aryl group, a substituted or unsubstituted C3-C30 cycloalkyl group, a substituted or unsubstituted C1-C30 heterocycloalkyl group, a substituted or unsubstituted C1-C30 heteroaryl group, a substituted or unsubstituted C2-C30 alkylaryl group, and a substituted or unsubstituted C2-C30 arylalkyl group,
L³ is one selected from a single bond, —O—, —OOC—, —COO—, —OCOO—, —NHCO—, —CONH—, —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 alkylarylene group, a substituted or unsubstituted C2-C30 arylalkylene group, and a group where at least one group of the foregoing groups is linked together,
L⁴ is one selected from a single bond, —O—, —OOC—, —COO—, —OCOO—, —NHCO—, —CONH—, —CO—, —SO₂—, a substituted or unsubstituted C1030 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 alkylarylene group, a substituted or unsubstituted C2-C30 arylalkylene group, and a group where at least one group of the foregoing groups is linked together, and
R⁸ is one of groups represented by the following Chemical Formulas 10 to 15, 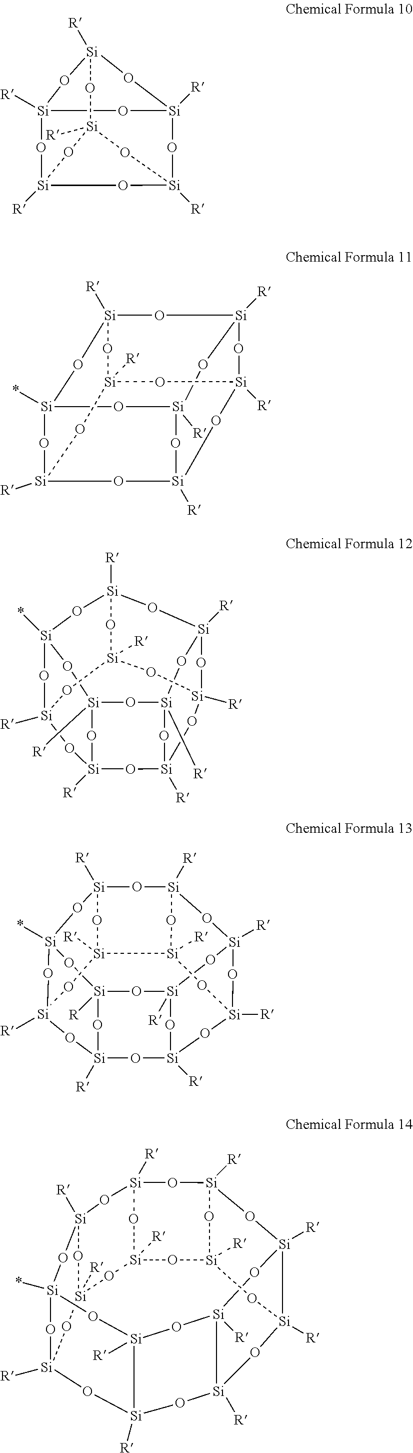 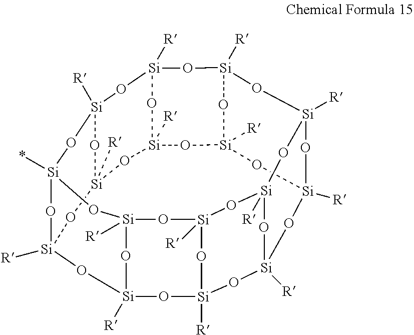
wherein, in the Chemical Formulas 10 to 15,
R′ are the same or different, and are independently one selected from hydrogen, a hydroxy group, a nitro group, a cyano group, an imino group (═NH, ═NR¹⁰¹, R¹⁰¹ is a C1 to C10 alkyl group), an amino group (—NH₂, —NH(R¹⁰²), —N(R¹⁰³)((R¹⁰⁴), wherein R¹⁰² to R¹⁰⁴ are independently a C1 to C10 alkyl group), an amidino group, a hydrazine group, a hydrazone group, a carboxyl group, a C1 to C30 alkyl group, a C1 to C30 alkylsilyl group, a C3 to C30 cycloalkyl group, a C2 to C30 heterocycloalkyl group, a C6 to C30 aryl group, a C2 to C30 heteroaryl group, a C1 to C30 alkoxy group, and a C1 to C30 fluoroalkyl group.

11. The organic/inorganic fouling resistant composite compound of claim 1, wherein a molar ratio of the first structural unit and the second structural unit in the at least one arm ranges from about 1 mol %: about 99 mol % to about 99 mol %: about 1 mol %.

12. The organic/inorganic fouling resistant composite compound of claim 3, wherein the L¹ is one selected from a single bond, —O—, —OOC—, —COO—, —OCOO—, —NW— (wherein W is hydrogen or a C1-C10 alkyl group), —CO—, —SO₂—, a substituted or unsubstituted C1-C30 alkylene group, a substituted or unsubstituted C5 to C30 arylene group, a substituted or unsubstituted C3-C30 cycloalkylene group, a substituted or unsubstituted C1-C30 heterocycloalkylene group, a substituted or unsubstituted C1-C30 heteroarylene group, a substituted or unsubstituted C2-C30 an alkylarylene group, a substituted or unsubstituted C2-C30 arylalkylene group, a substituted or unsubstituted silylene, a substituted or unsubstituted C2-C30 alkenyl group, a substituted or unsubstituted C2-C30 alkynyl group, and a group where at least one group of the foregoing groups is linked together.

13. The organic/inorganic fouling resistant composite compound of claim 1, wherein the vinyl-based structural first structural unit includes a first ethylene oxide group and a second ethylene oxide group extending from the first ethylene oxide group.

14. A fouling resistant membrane, comprising:
a surface layer including the organic/inorganic foul-resistant composite compound according to claim 1.

15. The fouling resistant membrane of claim 14, wherein the surface layer has a contact angle of about 10 to about 90 degrees.

16. The fouling resistant membrane of claim 14, wherein the surface layer has a thickness of about 0.01 μm to about 100 μm.

17. The fouling resistant membrane of claim 14 configured in the form of a comb-shaped polymer.

18. The fouling resistant membrane of claim 14, further comprising an inner layer under the surface layer,
wherein the inner layer includes at least one compound selected from a polyacrylate-based compound, a polymethacrylate-based compound, a polystyrene-based compound, a polycarbonate-based compound, a polyethylene terephthalate-based compound, a polyimide-based compound, a polybenzimidazole-based compound, a polybenzthiazole-based compound, a polybenzoxazole-based compound, a polyepoxy resin compound, a polyolefin-based compound, a polyphenylene vinylene compound, a polyamide-based compound, a polyacrylonitrile-based compound, a polysulfone-based compound, a cellulose-based compound, polyvinylidene fluoride (PVDF), polytetrafluoroethylene (PTFE), a polyvinylchloride (PVC) compound, and a combination thereof.

19. A water treatment membrane, comprising:
the fouling resistant membrane according claim 14,
wherein the fouling resistant membrane includes an inner layer under the surface layer, and
the inner layer is one selected from a microfiltration membrane, an ultrafiltration membrane, a nanofiltration membrane, a reverse osmotic membrane, and a forward osmotic membrane.

20. The water treatment membrane of claim 19, wherein the inner layer is a single membrane formed of a homogeneous material or a composite membrane including a plurality of layers formed of a heterogeneous material.

21. A method of preparing a fouling resistant membrane, comprising:
preparing a solution including the organic/inorganic fouling resistant composite compound according to claim 1 and a solvent, and
forming a surface layer by coating the solution on a surface of a preliminary membrane.

22. The method of claim 21, wherein the solution is coated on the surface of the preliminary membrane by one selected from solvent casting, spin casting, wet spinning, dry spinning, melt processing, and melt spinning.

23. The method of claim 21, wherein the solution includes about 0.1 to about 50 wt % of the organic/inorganic fouling resistant composite compound.
